(19) United States
(12) Patent Application Publication
(10) Pub. No.: US 2019/0075059 A1
(43) Pub. Date: Mar. 7, 2019

(54) Network and Management of Resources therein

(71) Applicant: Savvas Konstantinou, Nicosia (CY)

(72) Inventor: Savvas Konstantinou, Nicosia (CY)

(21) Appl. No.: 15/694,801

(22) Filed: Sep. 3, 2017

(51) Int. Cl. H04L 12/911; H04L 12/24

(52) U.S. Cl. CPC H04L 47/70; H04L 67/42; H04L 41/12

(57) ABSTRACT

A method, design and procedure providing a computer based network and corresponding system and method for the management of the resources of entities connected to the network by sharing the idle resources of the entities with geographically closer active entities in need of such resources in multiple ways in return of the rewards. The network may be connected to remote and neighboring networks allowing its active entities in need of such resources to make use of the entities connected to such remote/neighboring networks or resources thereof. The invention has revolutionary impact on the networking as it aims to provide efficient, smooth and reliable operation of the network.

### CROSS-REFERENCE TO RELATED APPLICATIONS

This application claims the benefit of U.S. Provisional Application Ser. No. 62/383,488 filed on 4 Sep. 2016.

### FIELD OF INVENTION

The present invention generally relates to networks and management of resources therein; and more specifically to a network for rendering resources for all clients connected to a particular network.

### STATEMENT REGARDING FEDERALLY SPONSORED RESEARCH OR DEVELOPMENT

(Not applicable)

### BACKGROUND OF THE INVENTION

High demand of graphical applications and videos increases the use of Graphics Processing Unit (GPU). To develop any game for consoles, mobile devices, personal computers and for web applications, developer may need variety of applications for various functionalities. For example, sub-applications corresponding to converting 2D to 3D videos, a collision detection, sound, scripting, animation, graphics and other applications are required for developing a gaming application. Further, for launching a game online or for creating a play environment for any game, particularly a game with graphics and video, a number of resources are required such as artificial intelligence tools, memory, different applications and/or modules corresponding to the game, applications for adding useful and user friendly features and the like.

The game engine technology exists in the industry that may be utilized for creating video games for various platforms including game consoles and personal computers. However, the one of the problems with such technology lies with video rendering around vegetation, water, dust particles and the like in multiple games. To get rid of such problem, upgraded drivers are required which further require high bandwidth to provide feasible and rational video transmission. Consequently, the issue of unstable user experience remains the same.

For online gaming, the resource rendering is highly important due to growing demand of online gaming, video applications and other graphics. Accordingly, online traffic increases due to less number of available resources and thus high latency. To allocate a separate system/resource for each online user is not practicable thanks to high cost and bandwidth.

The existing art may include network renders with the two nodes, active and idle, but the idle nodes never start the rendering, it simply acts like idle. The idle nodes keep waiting for job in the rendering network. If the idle node is started to render, it would keep on rendering but wouldn't finish. Even sometimes they would not start at all. So there is a need for some improved concepts to overcome these challenges.

The existing technology requires multiple servers including central server to manage the gaming machine and other servers such as a player tracking server, computation server, rendering server etc. The gaming machine may be a thin client or thick client machine to execute the communicated computerized instructions to control the games. The gaming machine sends the status information to the server when it is idle. It requires the resources and the additional information from the server. Thus, the art does not provide an efficient solution because it needs many servers and requires every bit of information from the separate server for the next process. To overcome these problems, the field was in dire need of an improved network framework to manage the resources.

There is a need of a framework that should enable the management of network resources for the benefit of the network users by providing efficient, reliable and time and cost effective solution to the existing problems and challenges in the field including, without limitation, the field of graphics and video gaming. The required framework should be capable to use the resources in the manner without requiring multiple servers, and thus, making the operation cost effective. Additionally, the required framework should enable an independent management of resources in a gaming environment by providing different useful features for the available nodes in the network. The framework should also be efficient enough to handle complex and large scale network rendering in order to ensure reliability for urgent requests from one or more nodes.

### SUMMARY OF INVENTION

The present invention provides a network and corresponding system and method for managing resources of entities in the networks. It is efficient to handle complex and large scale network rendering in order to ensure reliability for urgent requests from the nodes. The idle nodes make their rendering power and resources available to active nodes if the active nodes need such power and resources (node in need). The idle nodes may receive reward for providing the resources to the nodes in needs. The system may connect and coordinate with external network to explore and arrange for the resources need by the nodes in the local network. The exchange of the resources between the nodes of the network and external network widens the scope of the available resources. The nodes-in-need, which are geographically closer to the idle nodes, are served on the preferential basis to avoid latency in the performance. The idle nodes may solicit a list of available resources to the network to make it available for the nodes-in-need. Each node may act as a client and a server simultaneously based on the exchange of their respective resources between them preventing the need of multiple servers.

A thin node (client) may send a request to a thick node which may process the request of the client i.e. the application may run on the thick node while streamed to a thin node. In another situation, the process may run on the thin node which sends per frame render requests to the thick nodes, and then receives the frames back.

### BRIEF DESCRIPTION OF THE DRAWINGS

### Brief Description of Drawing

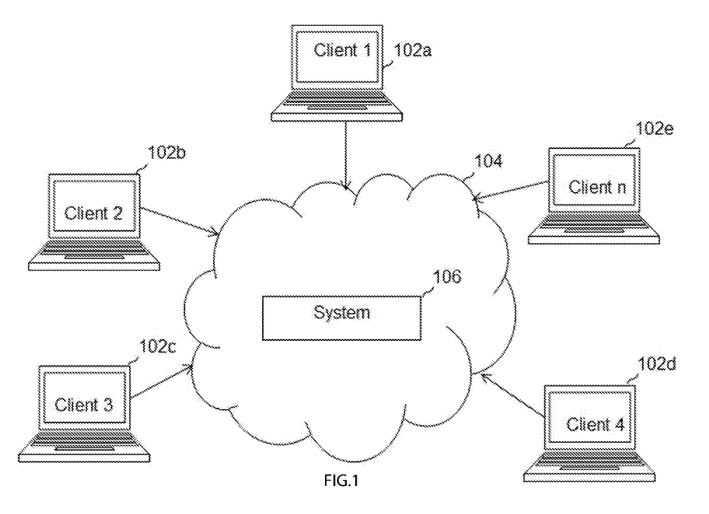

FIG. 1 illustrates an exemplary environment where the entities of the network shares their respective resources within the local network under various embodiments of the present invention;

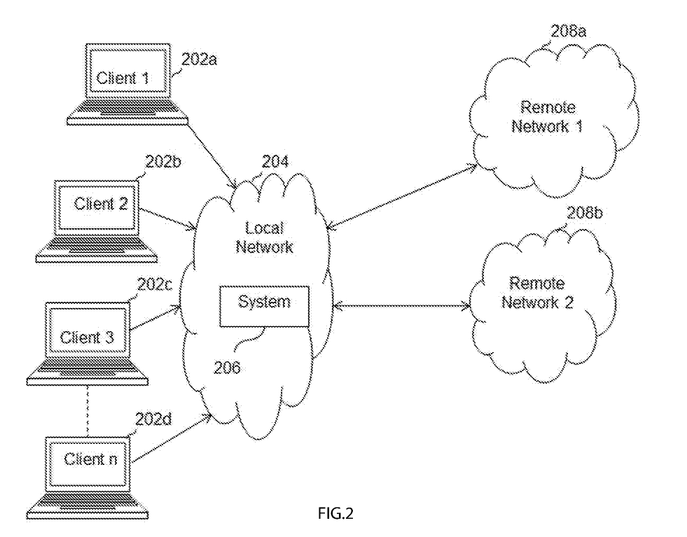

FIG. 2 illustrates another exemplary environment where the remote neighboring network or remote network (“external network”) is connected to the local network to share the idle resources of the remote network under various embodiments of the present invention;

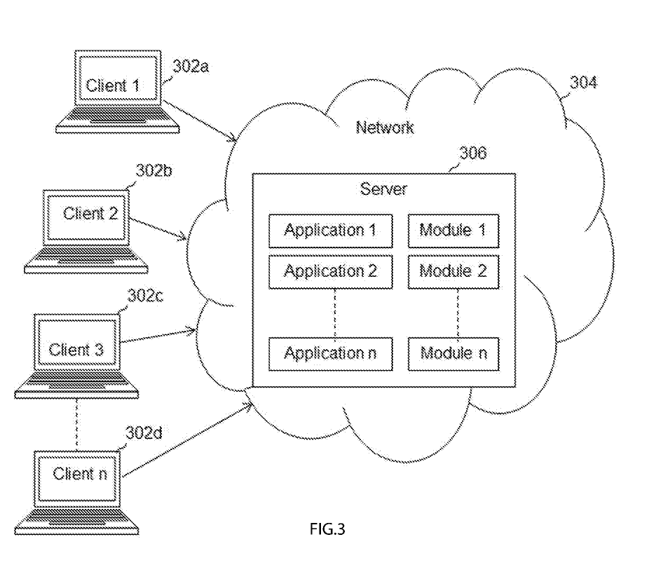

FIG. 3 illustrates an exemplary environment where the idle nodes solicit the list of the available idle resources to the network under various embodiments of the present invention; and

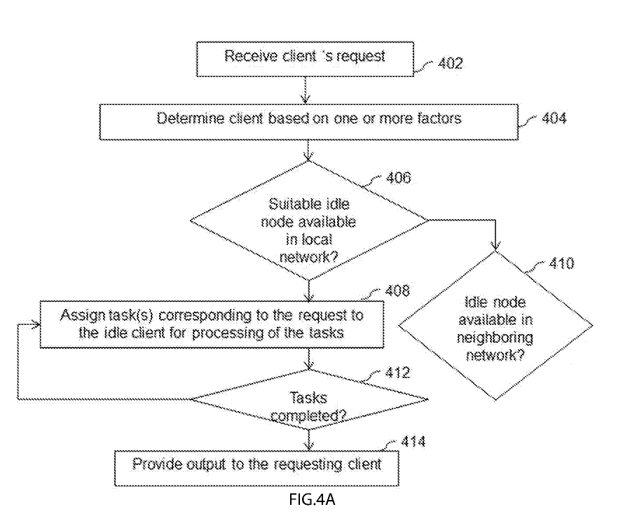

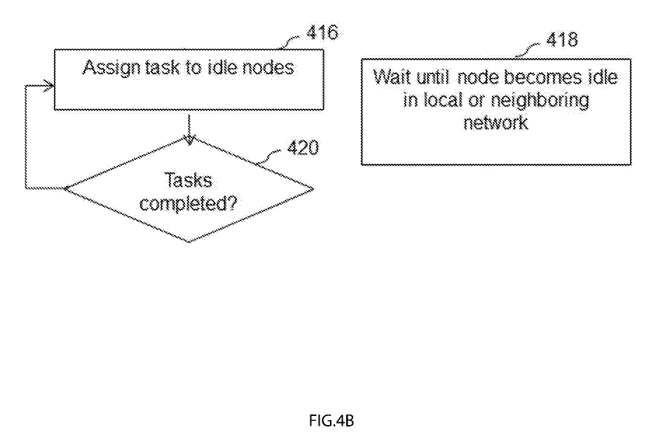

FIGS. 4A and 4B illustrate flow diagram of a method for rendering resources in a network in accordance with an embodiment of the invention.

### DETAILED DESCRIPTION OF THE INVENTION

A network may include a plurality of nodes connected to each other that may either be thin nodes or thick nodes. In such a network, thin nodes (clients) may delegate graphical intense work to thick nodes (servers/clients). In another embodiment, the idle nodes may determine the needs of the clients to render resources and applications to the clients whose needs have been determined.

In an embodiment of the present disclosure, the idle nodes may make their rendering power available for active nodes to use. The present disclosure provides the network operation that cannot be restricted to any server. All idle nodes (clients) may act as servers scattered across the world. Further, in another exemplary embodiment, an application may either run on the thick node while streamed to a thin node or it may run on the thin node that sends per frame render requests to the thick nodes and then receives the frames (processed) back.

Illustrative embodiments of the invention will be described in more details hereinafter with reference to the drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Throughout the following space, the like numbers refer to like elements throughout.

The “client(s)-in-need”, “node(s)-in-need” or “entity(ies)-in-need” means the client connected to the network which needs to perform a specific task and is in short of the resources required to perform such task. The “idle node(s)”, “idle client(s)” “idle entity(ies)” refers to the client connected to the local or neighboring or remote network and is not currently active or has idle resources that may be used by the node-in-need.

FIG. 1 illustrates an exemplary environment where various embodiments of the present invention are implemented. FIG. 1 illustrates the embodiment for providing network related services to plurality of entities i.e. Client 102a, Client 102b, Client 102c, Client 102d and Client 102e (hereinafter, may interchangeably be referred to as “entity” “clients”, “nodes”, “entities 102” or “entity 102”). Any entity 102 may either act as a client having resource requirements or as a server to serve the other client(s) for their resource requirement(s). If any entity 102 is idle entity or has any idle resource that may be utilized by other client(s)-in-need as per their resource requirement(s) to operate in the environment, the idle node may act as a server to provide such resource in response to the request of the node in need. In another embodiment, being part of the network, each entity 102 is aware of the requirements of other nodes. Based on such awareness, the idle node may render its resource to the node-in-need. For example, the node-in-need may require resources such as memory, CPU, GPU, applications and modules for various features associated with application such as graphical application; or the node-in-need may require an application for processing 3D video for an online gaming application. The idle node having such resources readily makes available such resources application and acts as a server for the node-in-need that may act as a client to receive authorization to access available resources of the idle node acting as a server. The plurality of entities 102 is connected together in a network 104.

In exemplary embodiments, the network 104 includes a system 106 to which each entity 102 are registered. The system 106 acquires information relating to each entity 102 including, but not limited to, the type of the entity 102, whether temporary or permanent, type of an application, time available for required resource utilization, urgency of the requirements, number of online users, available bandwidth, and available idle resources. The client 102 may be temporarily connected to the network 104 without registering on the system 106. For example, if an entity connected directly to the network 104 by registering to the system 106, the same may be referred to as permanent entity. Alternatively, if the entity 102 is not registered with the system and needs resources on demand basis then the entity may be considered as temporary or on-demand entity.

In an embodiment, the time at which each entity 102 may need to use particular resource(s) is determined. On the basis of such information, the urgency of the need of any node is determined. In addition, based on the number of online users of any application of the entities, such as gaming applications, the system 106 evaluates the network traffic, bandwidth and available idle resources of each entity 102. The entities 102 are informed of the available resources with each entity 102. The information relating to the available idle node or resources is conveyed to the entities 102 so that they may use the resources when they need them.

In the operation of the network, one or more clients 102 may serve the node-in-nodes 102 with the required resources. As illustrated in 108a and 108b, if the Client 102a needs the resources which are idle and are available with the Client 102b and Client 102b, the Client 102c, and the Client 102b and Client 102c will serve the same as servers. At the same time, the Client 102c also needs the resources which remain idle with the Client 102a, the Client 102a will act as a server for the Client 102c. Thus, the reciprocity of the use of the idle resources in the invention is also possible.

In an embodiment, a thin node (client) may send request to the thick node. The thick node may process the request of the thin node. This implies that an application, including, but not limited to, gaming applications, may either run on thick node while streamed to a thin node; or it (the application) may run on thin node that may send per frame render requests to the thick nodes then receives the frame back.

The idle clients connect their computers, mobile or other devices to the network 104. In return, the system 106 provides reward points to all those connected devices which are utilized by the network entities 102 in need of the resources. In another embodiment, the rewards may be provided by the node-in-need which used the idle node. In yet another embodiment, the Node-in-Need that utilizes the connected idle node may enable the idle node to access the idle resources of the node-in-need anytime in future. Further, in an embodiment, each node may access the idle resources of the other on the reciprocity and give-and-take basis.

The idle nodes which are geographically closer to the nodes-in-need serve them giving preference over the more distant clients. It helps to overcome the latency in rendering the resources. Based on their respective locations, the idle nodes may itself decide which of the idle nodes would serve the node-in-need. Alternatively, the system 106 may determine the best suitable idle nodes which are in the close proximity of the node-in-need to serve the same.

The system 106 stores the information relating to each node 102. If any time in future, the system receives the request from any nodes-in-need for the resources which are idle and are available with the node of which information is already stored with the system, the same will be utilized.

Referring to FIG. 2 that illustrates another environment where various embodiments of the present invention are implemented. As depicted, the Client-1 202a, Client-2 202b, Client-3 202c and up to a Client-n 202d (hereinafter may collectively be referred to as ‘entities 202’) form a local network 204. The local network 204 may include a system 206 for managing the activities of entities in the local network 204. The functionalities of the entities 202, the local network 204 and the system 206 are similar to that of 104, 104 and 106 respectively as shown in the FIG. 1. The local network 204 may be connected to remote networks or any neighboring networks which is not part of the local networks 204. As depicted in the FIG. 2, the local network 204 may be connected to the remote network 208a and the remote network 208b or any number of the remote networks (hereinafter, the remote network 208a and the remote network 2 208b may collectively and interchangeably be referred to as the “external network(s) 208”). Each remote network 208 may include a system similar to the one identified as system 206 in the FIG. 2. The system in the remote network 208 aims to interact among different networks. For example, if any of the entities 202 requires one or more resources for implementing an application and if no idle node exists in the local network 204, then the system 206 may coordinate with the external networks 208.

More specifically, if it is determined that required resources are not available or are not idle, the system 206 may interact with other external networks 208 to determine whether the required resources are available with any nodes connected to the external networks 208. For example, the system 206 may interact with other systems attached to the external networks 208 to determine the availability of the required resources. If it is found that the required resources are idle and available with any node on the external networks 208, the resources are accessed accordingly. Alternatively, the application may be performed at the external networks 208 by utilizing the idle nodes existed in the remote networks 208. In an embodiment, the system 206 may need to be authenticated to access any node forming part of the remote networks 208.

This may be beneficial in scenarios when the requested resources are important or urgent for the node-in-need to perform functionalities of an application, for instance, but not limited to, the graphic and video application, and no Idle Node exists in the local network 204. In such cases, either the required resources may be accessed directly by the node-in-need or task(s) may be implemented through the external networks 208. For example, a particular task of the node-in-need is assigned to an idle node of the remote networks 208. Once the tasks are processed or executed in any of the remote networks 208 by utilizing the available required resources of the idle node, the output thereof may be provided back to the node-in-need. Further, in an advantageous embodiment, an idle node from the external networks 208 may be connected to the local network 204 to avoid latency in rendering request of the node-in-need. In such cases, the connected node forming part of the external networks 208 may be rewarded either by exchange of resources or through points.

The embodiments relating to the present invention is not limited to the remote networks, but additional useful embodiments may be implemented in the light of the present disclosure.

FIG. 3 illustrates an exemplary environment where different embodiments of the present invention are implemented. As depicted, the Client 302a, Client 302b, Client 302c and up to the Client 302d (hereinafter may collectively be referred to as “entities 302”) may be connected to a network 304. As depicted, the network 304 includes a server 306 having a list of available resources such as, without limitation, the application 1, application 2 and so on up to application n and modules such as, without limitation, the module 1, module 2 and so on up to module n that may be utilized by the node-in-need connected to the network 304. In an embodiment, the idle nodes may solicit a list of available applications, modules, resources, games and corresponding features to the network 304. In this embodiment, any client (of entities 302) may login to the server 306 and browse the list for a specific application that the node-in-need would like to use. Once the required resource/application is found in the list, the same may be executed on the soliciting server i.e., the server 306 and accordingly, the streaming session may be started.

Further the idle nodes or the nodes having idle resources such as memory, application, modules, etc. may solicit the idle resources for the utilization thereof by the node-in-need. In return, the idle nodes may receive reward(s) for soliciting the idle resources. Such reward may be in the form of, but not limited to, points or in form of exchange of resources of the node-in-need in the times of need of the idle node.

The invention is not restricted to the features described above; there is variety of the embodiments that may be implemented along the lines of the present disclosure.

FIGS. 4A and 4B (hereinafter may collectively be referred to as “FIG. 4”) illustrate a flow diagram of a method for rendering resources in a network, in accordance with an embodiment of the invention. The FIG. 4 may be understood more clearly when it is read in conjunction with description of FIGS. 1-3. The order in which a method is performed is not intended to be construed as limitation of the invention because any number of the steps of the method may be combined in order to perform any desired method without going beyond the scope of the invention.

At step 402, the method may receive a client's request for the required resources. The request may correspond to one or more resources that may be required by a client (may interchangeably be referred to as ‘client-in-need’) to run an application. For example, the resources may include hardware resources or software resources such as (but not limited to) driver, graphics card, applications (for example, 2D to 3D converter etc.), modules, application features, memory, GPU etc. In an embodiment, this step is optional as the method may understand the client's needs without explicit request from the client.

At step 404, the method may determine the type and nature of the client based on one or more factors including, but not limited to, the requirements of the client, behavior of the client in the network, number of connected users, available applications of the client, and potential benefits to other clients based on the available resources with the client. For example, the method may determine whether the client connects its device to the network permanently or provisionally and may arrange the resources for the client based on the permanent or provisional type.

At the step 406, it is determined whether any suitable idle node or resources are available in a local network. If they are available, the method may proceed to the step 408. Alternatively, the method may use the step 410 in the search of the required resources on the external network.

At step 408, once the idle node is determined, one or more tasks corresponding to the request of the client-in-need may be assigned to the idle client for processing thereof. At step 412, it is evaluated whether the assigned tasks are completed or not; and if it is completed, the method may use the step 414 to provide output of the completed tasks to the client-in-need.

If the idle node is not available on the local network, upon its determination at step 406, then at step 410, the method explores the external networks to locate the idle node or resources. Once the idle node or resources are located, the method proceeds to the step 416 assigning the task to such idle node. Once it is completed at the step 420, the method delivers the completed work to the client-in-need on the line of the step 414.

In case the idle node is not available in the neighboring network too, the method may proceed to step 418 and wait for the node to become idle in the local or neighboring network. In addition to the waiting for the resources or node to become idle, the method may repeat the procedure from the step 404 and check if any idle node or resources are available in the local network 406, if not, then the method may proceed to the external network 410.

1. A method, design and procedure for the efficient management of the resources in the computer based network comprising:
Plurality of nodes connected to each other that may be thick node or thin node;
A system managing the activities of nodes connected to the network; and,
A server serving the nodes connected to the network.

2. A method, design and procedure of claim 1, wherein, the nodes perform their respective tasks and do the functions within the network including:
Allowing the idle resources to be used by the other nodes on the network while acting as a server;
Using the idle nodes or resources thereof while in need of such nodes or resources thereof;
Informing the system about the available idle resources;
Familiarizing themselves about the requirements of and idle resources available with each nodes; and
Working as a server having idle resources to other nodes in need of such resources or as a client requesting for the resources while being in need of such resources.

3. A method, design and procedure of claim 1, wherein, the nodes may be temporarily or permanently connected to the network without registering on the system.

4. A method, design and procedure of claim 1, wherein, the system may be connected to the neighbouring or remote networks.

5. A method, design and procedure of claim 1, wherein, the server has a list of available applications, modules, and similar other resources furnished by the idle nodes to the network that may be utilized by any nodes in need of such resources.

6. A method, design and procedure of claim 1, wherein a system registers the entities and acquires technical information relating to each node including, without limitation, the type of the entity, type of an application, time available for required resource utilization, urgency of the requirements, number of online users, available bandwidth, and available idle resources to be used by the entities in need of such resources.

7. A method, design and procedure of claim 1, wherein, a thin node (client) may send request to the thick node which may process the request of the thin node and deliver the processed requested job back to thin nodes.

8. A method, design and procedure of claim 1, wherein, the idle nodes serve the node in the need of resources giving preference to the nodes which are geographically closer to it over the more distant entities and, in addition to the system, the idle nodes may themselves decide which of the idle nodes would serve the node in need of the resources.

9. A method, design and procedure of claim 1, wherein, the system may;
communicate with the external network to check the availability of the idle resources on the external network(s) in the absence of the idle resources on the local network and arrange for the nodes in need of such resources or cause the task to be performed by the nodes on the external network(s) and deliver it back to the nodes requiring the job to be done;
wait in case no idle resources are available on the external network until the resources are available;
allow the idle nodes in the external network to connect to the local network; and
revisit the local network to check whether any nodes or the resources thereof are idle.

10. A method, design and procedure of claim 1, wherein, the rewards or incentives are provided by the system and the nodes in need of the resource(s) to idle node(s) for the use of its idle resources on the local or any external network.

11. A method, design and procedure of claim 1, wherein, the idle nodes solicit a list of available applications, modules, resources, games and corresponding features to the network to be used by any client.

12. A method, design and procedure of claim 1, wherein, the client may browse the list for the desired application that may be executed on the server and thereafter the streaming session starts.
